(19) United States
(12) Patent Application Publication
(10) Pub. No.: US 2024/0174806 A1
(43) Pub. Date: May 30, 2024

(54) HIGH TEMPERATURE RESISTANT SEMI-AROMATIC POLYAMIDE RESIN, PREPARATION METHOD, COMPOSITION AND ARTICLE THEREOF

(71) Applicants: Cathay Biotech Inc., Shanghai (CN); CIBT America Inc., Newark, DE (US)

(72) Inventors: Wutong FENG, Shanghai (CN); Yuanbo ZHAO, Shanghai (CN); Xiucai LIU, Shanghai (CN)

(73) Assignees: Cathay Biotech Inc., Shanghai (CN); CIBT America Inc., Newark, DE (US)

(21) Appl. No.: 18/432,799

(22) Filed: Feb. 5, 2024

Related U.S. Application Data
(63) Continuation of application No. PCT/CN2022/074277, filed on Jan. 27, 2022.

(30) Foreign Application Priority Data
Aug. 30, 2021 (CN) 202111003945.5

(51) Int. Cl. C08G 69/26

(52) U.S. Cl. CPC C08G 69/265

(57) ABSTRACT

The present application provides a high temperature resistant semi-aromatic polyamide resin and a preparation method thereof, a composition, and an article. Polymeric monomers of the polyamide resin include a diamine monomer and a diacid monomer, where the diamine monomer includes a diamine monomer A1 and a diamine monomer A2, and the diacid monomer includes a diacid monomer B1 and a diacid monomer B2. The carbon atom number C_{A1} of the diamine monomer A1 and the carbon atom number C_{A2} of the diamine monomer A2 satisfy that C_{A1}−C_{A2}≥4, the diacid monomer B1 is selected from aromatic dicarboxylic acids with a carbon atom number of 7-12 and derivatives thereof, and the diacid monomer B2 is selected from aliphatic dicarboxylic acids with a carbon atom number of 4-18.

### CROSS-REFERENCE TO RELATED APPLICATIONS

This application is a continuation of PCT Application No. PCT/CN2022/074277, filed on Jan. 27, 2022, which claims the priority of Chinese Patent Application CN202111003945.5, filed on Aug. 30, 2021, the entire contents of which are incorporated herein by reference.

### TECHNICAL FIELD

The present application relates to the field of high polymer materials, and specifically relates to a high temperature resistant semi-aromatic polyamide.

### BACKGROUND

With high heat resistance, dimensional stability, good mechanical strength and melting processability, high temperature resistant polyamide has been widely used in electronic devices, automotive engine peripheral components, aerospace, and other fields. Semi-aromatic polyamide with a long carbon chain is particularly important. A rigid benzene ring structure endows materials with excellent dimensional stability and mechanical strength, and a long carbon chain structure with low internal rotational site resistance endows materials with good toughness and low water absorption. However, due to a large number of entanglements of molecular chains of the semi-aromatic polyamide with a long carbon chain and poor fluidity of a melt, which bring great difficulties to the melt discharge stage of the one-step polymerization process and the injection moulding of the finished product.

At present, methods for improving the fluidity of a polymer are mainly adopted from the following aspects: (1) reducing the molecular weight of the polymer; (2) adding a flow modifier; (3) increasing the processing temperature; and (4) increasing the shearing rate or the shearing stress. However, all the above methods have the following inevitable problems. Although decrease of the molecular weight of the polymer can greatly decrease the melt viscosity and increase the melt fluidity of the polymer, mechanical properties of a material will be greatly reduced at the same time. When the flow modifier is added for melting and blending with the polyamide, the problems of compatibility between an additive and a matrix, precipitation and smell of the additive and the like shall also be taken into account. Although increase of the processing temperature can improve the fluidity of a polyamide melt, the problems of aging and degradation at high temperature, production of gel by crosslinking and the like will also be caused by a narrow processing window of the high temperature resistant polyamide and too high processing temperature, thereby further increasing the difficulties of melting and processing. The polyamide melt is a pseudoplastic fluid, and the apparent viscosity of the polyamide melt is decreased with increase of the shearing rate or the shearing stress. However, mechanical degradation of a material will also be caused by a too high shearing rate or a too high shearing stress.

A Chinese patent No. CN101200591B discloses a high temperature resistant nylon composite material with high fluidity. The fluidity is improved by introducing 0.1-10 wt. % of a flow modifier (such as a silicone compound, a montanic acid derivative and a high molecular wax lubricant) into a semi-aromatic polyamide matrix with poor fluidity. The flow modifier is treated with a coupling agent, followed by blending and granulation with the polyamide matrix to improve the compatibility. The flow modifier has excellent external and internal lubrication effects and can effectively reduce the friction force between the polyamide matrix and processing equipment as well as the friction force between polyamide molecular chains. A Chinese patent No. CN1368994A discloses a polyamide composition with high fluidity. The fluidity of polyamide with a high molecular weight is improved by adding 0.5-20 wt. % of a polyamide oligomer that has a higher melting point than a polyamide matrix with a high molecular weight into the polyamide matrix with a high molecular weight. Relative to the polyamide with a high molecular weight, the polyamide oligomer (with an average molecular weight of not greater than 5,000 g/mol) is used as a plasticizer to achieve a certain plasticizing effect, and has good compatibility with the polyamide matrix with a high molecular weight. However, the method has the disadvantages that two polyamides need to be prepared first and then are melted and blended, and a complicated process is achieved. A Chinese patent No. CN101798456B discloses a nylon composite material with a star-shaped branched structure. The fluidity is improved by adding 0.05-5 wt. % of a star-shaped branching agent containing at least 3 reactive functional groups (such as tricarboxylic benzenesulfonic acid, triaminotriphenyl methane and trihydroxypropylene oxide) into a polyamide matrix. The star-shaped branching agent is used as a plasticizer and enables rolling motion of molecules, thereby improving the fluidity of the polyamide during injection molding. However, relevant fluidity improvement data are not provided specifically. The method has the disadvantages that partial crosslinking of the polyamide matrix is caused by introduction of the branching agent, the fluidity of a melt is also greatly reduced by the crosslinking while moderate crosslinking is conducive to improvement of mechanical properties of a material, and how to find a balance between the two points is a difficult problem.

At present, methods for improving the fluidity of polyamide disclosed in patents are mainly adopted from the perspective of blending. The fluidity of a polyamide melt is improved by introducing a small molecular or high molecular lubricant, a polyamide with a low molecular weight same as a matrix, a polyolefin with a linear or branched structure, a liquid crystal polymer, a star-shaped branching agent and the like into a polyamide matrix based on twin-screw melt extrusion. By means of a melt blending method, the melt processing performance of the semi-aromatic polyamide with a long carbon chain can be improved to a certain extent. However, the problems of melting and discharging of the one-step polymerization process cannot be solved from the perspective of polymerization.

### SUMMARY

In order to address the above technical issues, a high temperature resistant semi-aromatic polyamide resin and a preparation method thereof are provided according to the present application, which may solve the problems of melting and discharging of the one-step polymerization process and improve the polyamide melt fluidity and stability.

Long-chain semi-aromatic polyamides have poor melt fluidity due to the intertwining of the long chains. In the present application, a third copolymer monomer (amine monomer A2) and a fourth copolymer monomer (acid monomer B2) are introduced for copolymerization. After a large number of experiments, it was found that copolyamides using two diamine monomers with a difference in the number of carbon atoms greater than or equal to 4 (i.e., C_{A1}−C_{A2}≥4) have better fluidity than those with a difference in the number of carbon atoms of less than 4 (i.e., C_{A1}−C_{A2}<4), and the larger the difference, the larger the degree of randomness of the polymer chain, the fewer the entanglements between the chains, and the better the fluidity of the copolyamides.

As used herein, the term “diamine monomer” is abbreviated as diamine. The C_{A1} is used for representing the carbon atom number of the diamine A1, and similarly, the C_{A2} is used for representing the carbon atom number of the diamine A2. Both the C_{A1} and the C_{A2} are an integer. A C_{A1}−C_{A2} difference is an integer.

In a first aspect, the application provides a semi-aromatic polyamide resin formed from polymeric monomers, and the polymeric monomers comprise a diamine monomer and a diacid monomer.

In some embodiments, the polymeric monomers of the polyamide resin include a diamine monomer and a diacid monomer, the diamine monomer includes a diamine monomer A1 and a diamine monomer A2, and the diacid monomer includes a diacid monomer B1 and a diacid monomer B2.

In some embodiments, a carbon atom number C_{A1} of the diamine monomer A1 and a carbon atom number C_{A2} of the diamine monomer A2 satisfy that C_{A1}−C_{A2}≥4.

In some embodiments, a carbon atom number C_{A1} of the diamine monomer A1 and a carbon atom number C_{A2} of the diamine monomer A2 satisfy that 4≤C_{A1}−C_{A2}≤10.

In some embodiments, the diamine monomer A1 is at least one selected from the group consisting of 1,8-octanediamine, 1,9-nonanediamine, 1,10-decanediamine, 1,11-undecanediamine, 1,12-dodecanediamine, 1,13-tridecanediamine and 1,14-tetradecanediamine.

In some embodiments, the diamine monomer A2 is at least one selected from the group consisting of 1,4-butanediamine, 1,5-pentanediamine, 1,6-hexanediamine, 1,7-heptanediamine, 1,8-octanediamine, 1,9-nonanediamine and 1,10-decanediamine.

In some embodiments, the diamine monomer A1 is selected from diamines with a carbon atom number of 8-14, and is preferably selected from diamines with a carbon atom number of 8-11.

In some embodiments, the diamine monomer A2 is selected from diamines with a carbon atom number of 4-10, and is preferably selected from diamines with a carbon atom number of 4-7.

In some embodiments, the diacid monomer B1 is at least one selected from aromatic dicarboxylic acids with a carbon atom number of 7-12 and derivatives thereof; and the diacid monomer B2 is at least one selected from aliphatic dicarboxylic acids with a carbon atom number of 4-18.

In some embodiments, the derivatives of the aromatic dicarboxylic acids with a carbon atom number of 7-12 include esters of the aromatic dicarboxylic acids with a carbon atom number of 7-12, and preferably include dimethyl terephthalate and dimethyl isophthalate.

In some embodiments, the diacid monomer B1 is at least one selected from the group consisting of terephthalic acid, dimethyl terephthalate, isophthalic acid and dimethyl isophthalate.

In some embodiments, the diacid monomer B2 is at least one selected from the group consisting of 1,4-succinic acid, 1,5-glutaric acid, 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid and 1,18-octadecanedioic acid.

In some embodiments, the diamine may be a diamine derived from a chemical substance or a biological substance, preferably a diamine derived from a biological substance.

In some embodiments, the diacid may be a diacid derived from a chemical substance or a biological substance, preferably a diacid derived from a biological substance.

In some embodiments, the polyamide resin comprises diamine units and diacid units prepared by polymerization between the diamine monomer and the diacid monomer, and a total weight of the diamine units and the diacid units is 97% or more of the polyamide resin.

In some embodiments, the total weight of the diamine units and the diacid units is 99% or more of the polyamide resin.

In some embodiments, the polyamide resin further comprises a polyamine, and the polyamine is at least one selected from the group consisting of thioether polyamine compounds, polyethyleneimine and polyaminopolyether amines.

In some embodiments, the polyamide resin comprises 0.8 wt. % or less by weight of the polyamine.

In some embodiments, the polyamide resin comprises 0.5 wt. % or less by weight of the polyamine.

In some embodiments, the polyamide resin comprises 0.2 wt. % or less by weight of the polyamine.

In some embodiments, the polyamide resin doesn't comprise a polyamine.

In some embodiments, the polyamide resin further comprises a polyamine, and the polyamine has a number-average molecular weight of 2,500-5,000 g/mol.

In some embodiments, small amounts of a polyamine are introduced during preparation of the polyamide resin for in-situ polymerization.

In some embodiments, small amounts of a polyamine are added into the polyamide resin for in-situ polymerization.

In some embodiments, the introduction of an appropriate amount of polyamine results in a trace amount of chemical bonding between the polymer chains of the polyamide, and the tensile, flexural and impact strengths are further improved.

In some embodiments, a molar ratio of the total mole of the diamine monomer A2 and the diacid monomer B2 to the total mole of all the polymeric monomers is between 0.040:1 and 0.099:1.

In some embodiments, the molar ratio of the sum of the diamine monomer A2 and the diacid monomer B2 in moles to the sum of all the polymeric monomers in moles is between 0.040:1 and 0.099:1.

In some embodiments, a molar ratio of the polymeric monomers satisfies that (A2 molar+B2 molar)/(A1 molar+B1 molar+A2 molar+B2 molar)=(0.040-0.099):1.

In some embodiments, a molar ratio of the diamine monomer to the diacid monomer is between 1.01:1 and 1.03:1.

In some embodiments, the polyamide resin further comprises an additive, and the additive is at least one selected from the group consisting of an end capping agent, a catalyst, a flame retardant, an antioxidant, an ultraviolet absorber, an infrared absorber, a crystallization nucleating agent, a fluorescent brightening agent, an antistatic agent, and combinations thereof.

In some embodiments, the additive constitutes 0.01% to 3% by weight of the polyamide resin.

In some embodiments, the polyamide resin at least comprises an antioxidant.

In some embodiments, the antioxidant is at least one selected from the group consisting of a phenolic antioxidant, an inorganic phosphate antioxidant, a phosphite antioxidant and a carbon free radical scavenger antioxidant.

In some embodiments, the polyamide resin at least comprises a catalyst.

In some embodiments, the catalyst is at least one selected from the group consisting of potassium hypophosphite, sodium hypophosphite, calcium hypophosphite, magnesium hypophosphite and zinc hypophosphite.

In some embodiments, the polyamide resin at least comprises an end capping agent.

In some embodiments, the end capping agent is at least one selected from the group consisting of acetic acid, benzoic acid and cyclohexanecarboxylic acid.

In some embodiments, the polyamide resin has a relative viscosity of 1.8-2.6, preferably 2.0-2.5.

In some embodiments, the polyamide resin has a melting point of 265-315° C., preferably 271-310° C.

In some embodiments, the polyamide resin has a tensile strength of 65-105 MPa, preferably 75-95 MPa.

In some embodiments, the polyamide resin has a bending strength of 80-140 MPa, preferably 90-125 MPa.

In some embodiments, the polyamide resin has a flow length equal to or greater than 600 mm, preferably equal to or greater than 850 mm.

In a second aspect, the present application provides a method for preparing the high temperature resistant semi-aromatic polyamide resin listed above.

In some embodiments, the method comprises:
heating an aqueous solution of a polyamide salt (i.e., polyamide salt solution) to 120-140° C., concentrating the aqueous solution, and then heating the aqueous solution to 230-260° C. for reaction; and reducing pressure to 0-0.1 MPa (gauge pressure) by degassing; wherein the aqueous solution of the polyamide salt is formed from the polymeric monomers and water.

In some embodiments, the method comprises the following steps:
heating an aqueous solution of a polyamide salt to 120-140° C., draining water out to concentrate the aqueous solution, and then heating the aqueous solution to 230-260° C. for reaction; and reducing the pressure to 0-0.1 MPa (gauge pressure) by degassing.

In some embodiments, the method comprises:
heating an aqueous solution of a polyamide salt to 120-140° C., concentrating the aqueous solution and then heating the aqueous solution to 240-255° C. for reaction; and reducing the pressure to 0-0.1 MPa (gauge pressure) by degassing.

A person skilled in the art knows that the polyamide salt is also known as a nylon salt. The nylon salt is a salt formed by a reaction between the polymeric monomers (including a diamine monomer A1, a diamine monomer A2, a diacid monomer B1 and a diacid monomer B2), and the nylon salt is subjected to a polycondensation reaction to obtain a polyamide.

In some embodiments, concentrating the aqueous solution comprises draining water out to achieve a polyamide salt weight concentration of 40 wt. %-80 wt. %.

In some embodiments, concentrating the aqueous solution comprises draining water out to achieve a polyamide salt weight concentration of 55 wt. %-65 wt. %.

In some embodiments, the reaction is carried out for 0.5-2 h.

In some embodiments, the reaction is carried out for 1-1.5 h.

In some embodiments, the pressure is maintained at 2.0-3.5 MPa during the reaction.

In some embodiments, the pressure is maintained at 2.5-3 MPa during the reaction.

In some embodiments, reducing the pressure to 0-0.02 MPa (gauge pressure) by degassing.

Unless otherwise stated or apparently contradictory, the pressure in the present application refers to gauge pressure.

In some embodiments, the reaction system has a temperature of 295-335° C. after reducing pressure to 0-0.1 MPa (gauge pressure) by degassing.

In some embodiments, before heating an aqueous solution of a polyamide salt, the method further comprises: mixing polymeric monomers and water, heating to 70-95° C., and optionally holding the temperature at 70-95° C. for 0.5-3 hours to form the aqueous solution of the polyamide salt.

In some embodiments, before heating an aqueous solution of a polyamide salt, the method further comprises: adding a diamine monomer A1, a diamine monomer A2, a diacid monomer B1 and a diacid monomer B2 into water, mixing and heating the thus obtained system to 70-95° C., and optionally holding the temperature at 70-95° C. for 0.5-3 hours to form an aqueous solution of a polyamide salt.

In some embodiments, before heating an aqueous solution of a polyamide salt, the method further comprises: adding a diamine monomer A1, a diamine monomer A2, a diacid monomer B1 and a diacid monomer B2 into water, mixing and heating the thus obtained system to 70-90° C., and optionally performing heat preservation at 70-90° C. for 0.5-3 hours to form an aqueous solution of a polyamide salt.

In some embodiments, optionally holding the temperature at 70-95° C. for 0.5-2 hours to form an aqueous solution of a polyamide salt.

In some embodiments, after reducing pressure to 0-0.1 MPa (gauge pressure) by degassing, the method further comprises: vacuumizing to a vacuum degree of −0.02 MPa or less, and optionally, maintaining the vacuum degree for 0-300 s.

In some embodiments, after reducing pressure to 0-0.1 MPa (gauge pressure) by degassing, the method further comprises: vacuumizing to a vacuum degree of −0.1 MPa to −0.05 MPa, and optionally, maintaining the vacuum degree for 0-300 s, preferably 0-90 s, more preferably 5-90 s, and more preferably 5-50 s.

In some embodiments, after vacuumizing, the method further comprises: discharging, stretching into strips and pelletizing.

In some embodiments, the stretching into strips and pelletizing is performed by water cooling, and the temperature of cooling water is, for example, 10-30° C.

In some embodiments, the method further comprises a adding an additive at any step of the method, and the additive is at least one selected from the group consisting of an end capping agent, a catalyst, a flame retardant, an antioxidant, an ultraviolet absorber, an infrared absorber, a crystallization nucleating agent, a fluorescent brightening agent, an antistatic agent, and combinations thereof.

In some embodiments, the method further comprises adding an additive at the step of mixing polymeric monomers and water, at the step of heating an aqueous solution of a polyamide salt to 120-140° C., or at the step of heating the aqueous solution to 230-260° C. for reaction.

In some embodiments, the mixing polymeric monomers and water is carried out in an atmosphere of nitrogen or an inert gas. The inert gas comprises argon or helium.

In some embodiments, any one or more of the steps of the method is carried out in an atmosphere of nitrogen or an inert gas. The inert gas comprises argon or helium.

In some embodiments, the quality of the additive accounts for 0.01 wt. %-3 wt. % of the total mass of the polymeric monomers, and the additive is at least one selected from the group consisting of an end capping agent, a catalyst, a flame retardant, an antioxidant, an ultraviolet absorber, an infrared absorber, and a crystallization nucleating agent.

In some embodiments, the end capping agent is at least one selected from the group consisting of C₂₋₁₆ aliphatic carboxylic acids, C₇₋₁₀ aromatic carboxylic acids, and combinations thereof. The aliphatic carboxylic acid end capping agent is structurally a monocarboxylic acid with a linear chain, a branched chain, or a ring structure, and is preferably a saturated monocarboxylic acid with a linear chain, a branched chain or a ring structure.

In some embodiments, the end capping agent is acetic acid, benzoic acid or cyclohexanecarboxylic acid.

In some embodiments, the catalyst selected form phosphates or hypophosphites, preferably phosphates of alkali metals and/or alkaline earth metals, and hypophosphites of alkali metals and/or alkaline earth metals. Preferably selected form one or more of potassium hypophosphite, sodium hypophosphite, calcium hypophosphite and magnesium hypophosphite or combinations thereof.

In some embodiments, the antioxidant is selected from a phenolic antioxidant, an inorganic phosphate antioxidant, a phosphite antioxidant and a carbon free radical scavenger antioxidant or combinations thereof.

In some embodiments, the method comprises:
(a) mixing a diamine monomer A1, a diamine monomer A2, a diacid monomer B1, a diacid monomer B2 and water, heating to 70-90° C., and holding the temperature at 70-95° C. for 0.5-3 hours to form an aqueous solution of a polyamide salt;
(1) heating the polyamide salt solution to 120-140° C., concentrating the polyamide salt solution comprises draining water out to achieve a polyamide salt weight concentration of 40-80 wt. %, and then heating the polyamide salt solution to 240-255° C. for reaction at a pressure of 2.5-3 MPa for 0.5-2 h;
(2) reducing the pressure of the reaction system to 0-0.1 MPa (gauge pressure) by degassing, and the reaction system has a temperature of 295-335° C. after reducing pressure to 0-0.1 MPa (gauge pressure) by degassing;
(3) vacuumizing to a vacuum degree of −0.1 MPa to −0.05 MPa, and maintaining the vacuum degree for 0-300 s; and
(4) discharging, stretching into strips, and pelletizing;
the related parameters in step (a) and steps (1) to (4) are preferably defined as described above.

In some embodiments, the method further comprises adding an additive at any stage of step (a), step (1), step (2), optional step (3) and step (4).

In a third aspect, the present application provides a composition. The composition comprises the semi-aromatic polyamide resin listed above.

In some embodiments, the composition comprises a semi-aromatic polyamide resin prepared by the methods listed above.

In some embodiments, the composition comprises a semi-aromatic polyamide resin prepared by using polymeric monomers, wherein the polymeric monomers comprise a diamine monomer and a diacid monomer, wherein the diamine monomer comprises a diamine monomer A1 and a diamine monomer A2, and the diacid monomer comprises a diacid monomer B1 and a diacid monomer B2; a carbon atom number C_{A1} of the diamine monomer A1 and a carbon atom number C_{A2} of the diamine monomer A2 satisfy that C_{A1}−C_{A2}≥4; the diamine monomer A1 is at least one selected from the group consisting of 1,8-octanediamine, 1,9-nonanediamine, 1,10-decanediamine, 1,11-undecanediamine, 1,12-dodecanediamine, 1,13-tridecanediamine, and 1,14-tetradecanediamine; the diamine monomer A2 is at least one selected from the group consisting of 1,4-butanediamine, 1,5-pentanediamine, 1,6-hexanediamine, 1,7-heptanediamine, 1,8-octanediamine, 1,9-nonanediamine, and 1,10-decanediamine; the diacid monomer B1 is at least one selected from aromatic dicarboxylic acids with a carbon atom number of 7-12 and derivatives thereof; and the diacid monomer B2 is at least one selected from aliphatic dicarboxylic acids with a carbon atom number of 4-18, or the semi-aromatic polyamide resin is prepared by: heating an aqueous solution of a polyamide salt to 120-140° C., concentrating the aqueous solution, and then heating the aqueous solution to 230-260° C. for reaction; and reducing pressure to 0-0.1 MPa (gauge pressure) by degassing, wherein the aqueous solution of the polyamide salt is formed from the polymeric monomers and water.

In a forth aspect, the present application provides an article comprising the semi-aromatic polyamide resin listed above, and the article is selected from the group consisting of electronic devices, automotive engine peripheral components, aerospace, and other articles for use in high temperature resistant fields.

In a fifth aspect, the present application provides a product prepared by using the semi-aromatic polyamide resin according to any one of the above descriptions or the composition as a raw material.

The present application at least has the following advantages.

1. Due to mutual entanglement of long chains of a long-chain semi-aromatic polyamide, the polyamide melt has fluidity deviation. In the present application, a third comonomer and a fourth comonomer are introduced for copolymerization. It is found that a high temperature resistant semi-aromatic polyamide resin obtained has better fluidity when the difference between the carbon atom numbers of the used two diamine monomers is equal to or greater than 4. In addition, a larger difference indicates a higher degree of irregularity of polymer chains, less entanglement of the chains and better fluidity of a copolyamide.

2. A one-step condensation and polymerization process of the high temperature resistant semi-aromatic polyamide of the present application has the advantages that melting and discharging are easier, and the polyamide melt has good fluidity and stability.

### DETAILED DESCRIPTION

Unless otherwise defined, all technical and scientific terms used herein have the same meaning as commonly understood by one of ordinary skill in the art to which this application belongs. Although methods and materials similar or equivalent to those described herein can be used in the practice or testing of the present embodiments, suitable methods and materials are described below. The materials, methods, and Examples described herein are illustrative only and not intended to be limiting. The following examples are provided to describe the application in further detail. These examples, which set forth a preferred mode presently contemplated for carrying out the invention, are intended to illustrate and not to limit the invention.

The polyamides obtained in Examples 1-13 and Comparative Examples 1-3 below were tested as follows, and the tests results are shown in Table 1.

Melting point was tested with reference to the standard ISO 11357-3, and heating rate is 20° C./min.

Relative viscosity ηᵣ was tested as follows:
a concentrated sulfuric acid method using an Ubbelohde viscometer includes: accurately weighing 0.5±0.0002 g of a dried polyamide sample, adding 50 mL of concentrated sulfuric acid (96%) to dissolve the sample, and measuring and recording the flow time (t₀) of the concentrated sulfuric acid and the flow time (t) of the polyamide solution in a constant-temperature water bath at 25±0.02° C. A calculation formula of the relative viscosity is as follows: relative viscosity ηᵣ=t/t₀; where t refers to the flow time of the polyamide solution; and t₀ refers to the flow time of the concentrated sulfuric acid as a solvent.

Methods for testing mechanical properties are as follows: a bending test is carried out with reference to the standard ISO-178, and the test is carried out at 2 mm/min; a tensile test is carried out with reference to the standard ISO-572-2, and the test is carried out at 50 mm/min; and an impact test is carried out with reference to the standard ISO 180.

An Archimedes helix flow length (i.e., flow length) test is carried out at a temperature that is 25° C. higher than the polyamide melting point and at an injection pressure of 80 bar.

In the below examples and comparative examples, the additives are as follows: the antioxidant is BRUGGOLEN H10 (Bruggemann); the end capping agent is acetic acid; and the catalyst is sodium hypophosphite.

Unless otherwise stated or apparently contradictory, “%” in the present application and the examples represents a mass percentage relative to the total mass of polymeric monomers.

### Example 1

9.28 mol of 1,9-nonanediamine, 9.10 mol of terephthalic acid, 0.90 mol of 1,5-pentanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained solution was heated to 90° C. in a nitrogen atmosphere and maintained at the temperature for 1 h to prepare a 50 wt. % (the weight concentration of the polyamide salt) polyamide salt solution. The polyamide salt solution was heated to 130° C. and concentrated to 65 wt. % by draining water out. Then, the polyamide salt solution was heated to 240° C. for reaction at a pressure of 2.5 MPa for 1 h. The pressure of the reaction system was reduced to 0 MPa (gauge pressure) by degassing, where the reaction system had a temperature of 317° C. after the reduction of pressure was completed. Then, a copolymer melt was obtained by vacuumizing to −0.07 MPa for 20 s. The copolymer melt was discharged, stretched into strips, and pelletized to obtain a high temperature resistant semi-aromatic polyamide.

### Example 2

9.28 mol of 1,9-nonanediamine, 9.10 mol of terephthalic acid, 0.90 mol of 1,5-pentanediamine, 0.90 mol of adipic acid, 0.8% of polyethyleneimine with a molecular weight of 3,000, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a 50 wt. % polyamide salt solution. The polyamide salt solution was heated to 130° C. and concentrated to 65 wt. % by draining water out. Then, the polyamide salt solution was heated to 240° C. to carry out a reaction at a pressure of 2.5 MPa for 1 h. The pressure of the reaction system was reduced to 0 MPa (gauge pressure) by degassing, where the reaction system had a temperature of 317° C. after the reduction of pressure was completed. Then, a copolymer melt was obtained by vacuumizing to −0.07 MPa for 20 s. The copolymer melt was discharged, stretched into strips, and pelletized to obtain a high temperature resistant semi-aromatic polyamide.

### Example 3

9.28 mol of 1,9-nonanediamine, 9.10 mol of terephthalic acid, 0.90 mol of 1,5-pentanediamine, 0.90 mol of adipic acid, 0.4% of polyethyleneimine with a molecular weight of 3,000, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a 50 wt. % polyamide salt solution. The polyamide salt solution was heated to 130° C. and concentrated to 65 wt. % by draining water out. Then, the polyamide salt solution was heated to 240° C. to carry out a reaction at a pressure of 2.5 MPa for 1 h. The pressure of the reaction system was reduced to 0 MPa (gauge pressure) by degassing, where the reaction system had a temperature of 317° C. after the reduction of pressure was completed. Then, a copolymer melt was obtained by vacuumizing to −0.07 MPa for 20 s. The copolymer melt was discharged, stretched into strips, and pelletized to obtain a high temperature resistant semi-aromatic polyamide.

### Example 4

9.20 mol of 1,10-decanediamine, 9.10 mol of terephthalic acid, 0.90 mol of 1,5-pentanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a 50 wt. % polyamide salt solution. The polyamide salt solution was heated to 130° C. and concentrated to 60 wt. % by draining water out. Then, the polyamide salt solution was heated to 245° C. to carry out a reaction at a pressure of 2.6 MPa for 1.2 h. The pressure of the reaction system was reduced to 0.01 MPa (gauge pressure) by degassing, where the reaction system had a temperature of 323° C. after the reduction of pressure was completed. Then, a copolymer melt was obtained by vacuumizing to −0.08 MPa for 10 s. The copolymer melt was discharged, stretched into strips, and pelletized to obtain a high temperature resistant semi-aromatic polyamide.

### Example 5

9.21 mol of 1,11-undecanediamine, 9.10 mol of terephthalic acid, 0.90 mol of 1,5-pentanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a 50 wt. % polyamide salt solution. The polyamide salt solution was heated to 135° C. and concentrated to 70 wt. % by draining water out. Then, the polyamide salt solution was heated to 245° C. to carry out a reaction at a pressure of 3.0 MPa for 1.5 h. The pressure of the reaction system was reduced to 0 MPa (gauge pressure) by degassing, where the reaction system had a temperature of 309° C. after the reduction of pressure was completed. Then, a copolymer melt was obtained by vacuumizing to −0.06 MPa for 30 s. The copolymer melt was discharged, stretched into strips, and pelletized to obtain a high temperature resistant semi-aromatic polyamide.

### Example 6

9.20 mol of 1,12-dodecanediamine, 9.10 mol of terephthalic acid, 0.90 mol of 1,5-pentanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 250° C. to carry out a reaction at a pressure of 3.0 MPa for 2 h. The pressure of the reaction system was reduced to 0.01 MPa (gauge pressure) by degassing, where the reaction system had a temperature of 308° C. after the reduction of pressure was completed. Then, a copolymer melt was obtained by vacuumizing to −0.09 MPa for 30 s. The copolymer melt was discharged, stretched into strips, and pelletized to obtain a high temperature resistant semi-aromatic polyamide.

### Example 7

9.20 mol of 1,12-dodecanediamine, 9.10 mol of terephthalic acid, 0.90 mol of 1,5-pentanediamine, 0.90 mol of adipic acid, 0.8% of polyethyleneimine with a molecular weight of 3,000, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 250° C. to carry out a reaction at a pressure of 3.0 MPa for 2 h. The pressure of the reaction system was reduced to 0.01 MPa (gauge pressure) by degassing, where the reaction system had a temperature of 308° C. after the reduction of pressure was completed. Then, a copolymer melt was obtained by vacuumizing to −0.09 MPa for 30 s. The copolymer melt was discharged, stretched into strips, and pelletized to obtain a high temperature resistant semi-aromatic polyamide.

### Example 8

9.23 mol of 1,13-tridecanediamine, 9.10 mol of terephthalic acid, 0.90 mol of 1,5-pentanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 255° C. to carry out a reaction at a pressure of 3.0 MPa for 2 h. The pressure of the reaction system was reduced to 0.01 MPa (gauge pressure) by degassing, where the reaction system had a temperature of 301° C. after the reduction of pressure was completed. Then, a copolymer melt was obtained by vacuumizing to −0.10 MPa for 10 s. The copolymer melt was discharged, stretched into strips, and pelletized to obtain a high temperature resistant semi-aromatic polyamide.

### Example 9

9.23 mol of 1,13-tridecanediamine, 9.10 mol of terephthalic acid, 0.90 mol of 1,6-hexanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 255° C. to carry out a reaction at a pressure of 3.0 MPa for 2 h. The pressure of the reaction system was reduced to 0.01 MPa (gauge pressure) by degassing, where the reaction system had a temperature of 303° C. after the reduction of pressure was completed. Then, a copolymer melt was obtained by vacuumizing to −0.10 MPa for 10 s. The copolymer melt was discharged, stretched into strips, and pelletized to obtain a high temperature resistant semi-aromatic polyamide.

### Example 10

9.76 mol of 1,10-decanediamine, 9.48 mol of terephthalic acid, 0.52 mol of 1,5-pentanediamine, 0.52 mol of octanedioic acid, 0.02% of sodium hypophosphite, 0.3% of BRUGGOLEN H10, 0.20% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 130° C. and concentrated to 60 wt. % by draining water out. Then, the polyamide salt solution was heated to 245° C. to carry out a reaction at a pressure of 2.6 MPa for 1.2 h. The pressure of the reaction system was reduced to 0.01 MPa (gauge pressure) by degassing, where the reaction system had a temperature of 334° C. after the reduction of pressure was completed. Then, a copolymer melt was obtained by vacuumizing to −0.08 MPa for 10 s. The copolymer melt was discharged, stretched into strips, and pelletized to obtain a high temperature resistant semi-aromatic polyamide.

### Example 11

9.20 mol of 1,9-nonanediamine, 9.02 mol of terephthalic acid, 0.98 mol of 1,5-pentanediamine, 0.98 mol of 1,10-decanedioic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 130° C. and concentrated to 65 wt. % by draining water out. Then, the polyamide salt solution was heated to 240° C. to carry out a reaction at a pressure of 2.5 MPa for 1 h. The pressure of the reaction system was reduced to 0 MPa (gauge pressure) by degassing, where the reaction system had a temperature of 313° C. after the reduction of pressure was completed. Then, a copolymer melt was obtained by vacuumizing to −0.07 MPa for 20 s. The copolymer melt was discharged, stretched into strips, and pelletized to obtain a high temperature resistant semi-aromatic polyamide.

### Example 12

9.47 mol of 1,11-undecanediamine, 9.24 mol of terephthalic acid, 0.76 mol of 1,6-hexanediamine, 0.76 mol of 1,12-dodecanedioic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 135° C. and concentrated to 70 wt. % by draining water out. Then, the polyamide salt solution was heated to 245° C. to carry out a reaction at a pressure of 3.0 MPa for 1.5 h. The pressure of the reaction system was reduced to 0 MPa (gauge pressure) by degassing, where the reaction system had a temperature of 301° C. after the reduction of pressure was completed. Then, a copolymer melt was obtained by vacuumizing to −0.06 MPa for 30 s. The copolymer melt was discharged, stretched into strips, and pelletized to obtain a high temperature resistant semi-aromatic polyamide.

### Example 13

9.23 mol of 1,13-tridecanediamine, 9.10 mol of terephthalic acid, 0.90 mol of 1,8-octanediamine, 0.90 mol of adipic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 255° C. to carry out a reaction at a pressure of 3.0 MPa for 2 h. The pressure of the reaction system was reduced to 0.01 MPa (gauge pressure) by degassing, where the reaction system had a temperature of 298° C. after the reduction of pressure was completed. Then, a copolymer melt was obtained by vacuumizing to −0.10 MPa for 10 s. The copolymer melt was discharged, stretched into strips, and pelletized to obtain a high temperature resistant semi-aromatic polyamide.

### Comparative Example 1

9.23 mol of 1,13-tridecanediamine, 9.10 mol of terephthalic acid, 0.90 mol of 1,12-dodecanediamine, 0.90 mol of 1,12-dodecanedioic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 140° C. and concentrated to 70 wt. % by draining water out. Then, the polyamide salt solution was heated to 255° C. to carry out a reaction at a pressure of 3.0 MPa for 2 h. The pressure of the reaction system was reduced to 0.01 MPa (gauge pressure) by degassing, where the reaction system had a temperature of 296° C. after the reduction of pressure was completed. Then, a copolymer melt was obtained by vacuumizing to −0.10 MPa for 10 s. The copolymer melt was discharged, stretched into strips, and pelletized to obtain a polyamide.

### Comparative Example 2

9.20 mol of 1,10-decanediamine, 9.10 mol of terephthalic acid, 0.90 mol of 1,9-nonanediamine, 0.90 mol of 1,12-dodecanedioic acid, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 130° C. and concentrated to 60 wt. % by draining water out. Then, the polyamide salt solution was heated to 245° C. to carry out a reaction at a pressure of 2.6 MPa for 1.2 h. The pressure of the reaction system was reduced to 0.01 MPa (gauge pressure) by degassing, where the reaction system had a temperature of 317° C. after the reduction of pressure was completed. Then, a copolymer melt was obtained by vacuumizing to −0.08 MPa for 10 s. The copolymer melt was discharged, stretched into strips, and pelletized to obtain a polyamide.

### Comparative Example 3

9.20 mol of 1,10-decanediamine, 9.10 mol of terephthalic acid, 0.90 mol of 1,5-pentanediamine, 0.90 mol of adipic acid, 1.5% of polyethyleneimine with a molecular weight of 3,000, 0.03% of sodium hypophosphite, 0.3% of BRUGGOLEN H10, 0.24% of acetic acid and water were mixed evenly at a stirring rate of 70 rpm, the thus obtained system was heated to 90° C. in a nitrogen atmosphere and maintained at the temperature for 1 h to prepare a polyamide salt solution with a concentration of 50 wt. %. The polyamide salt solution was heated to 130° C. and concentrated to 60 wt. % by draining water out. Then, the polyamide salt solution was heated to 245° C. to carry out a reaction at a pressure of 2.6 MPa for 1.2 h. The pressure of the reaction system was reduced to 0.01 MPa (gauge pressure) by degassing, where the reaction system had a temperature of 323° C. after the reduction of pressure was completed. Then, a copolymer melt was obtained by vacuumizing to −0.08 MPa for 10 s. The copolymer melt was discharged, stretched into strips, and pelletized to obtain a polyamide.

TABLE 1

| | | | | | | Notch | |
|---|---|---|---|---|---|---|---|
| | | | Melting | Tensile | Bending | impact | Flow |
| | | | point | strength | strength | strength | length |
| Example | C_{A1} − C_{A2} | ηᵣ | (° C.) | (MPa) | (MPa) | (kJ/m²) | (mm) |
| Example 1 | 4 | 2.32 | 292 | 86 | 117 | 8.4 | 1100 |
| Example 2 | 4 | 2.36 | 292 | 90 | 121 | 9.6 | 1030 |
| Example 3 | 4 | 2.35 | 292 | 89 | 119 | 9.2 | 1060 |
| Example 4 | 5 | 2.36 | 298 | 87 | 110 | 10.4 | 1040 |
| Example 5 | 6 | 2.32 | 284 | 85 | 105 | 10.8 | 990 |
| Example 6 | 7 | 2.38 | 283 | 84 | 98 | 12.6 | 950 |
| Example 7 | 7 | 2.36 | 283 | 89 | 100 | 13.1 | 900 |
| Example 8 | 8 | 2.36 | 276 | 78 | 95 | 14.8 | 920 |
| Example 9 | 7 | 2.36 | 278 | 80 | 98 | 13.5 | 900 |
| Example 10 | 5 | 2.33 | 309 | 94 | 113 | 9.9 | 880 |
| Example 11 | 4 | 2.38 | 288 | 77 | 109 | 7.8 | 1080 |
| Example 12 | 5 | 2.36 | 276 | 90 | 109 | 9.7 | 930 |
| Example 13 | 5 | 2.35 | 273 | 75 | 90 | 12.9 | 880 |
| Comparative | 1 | 2.32 | 271 | 74 | 87 | 12.8 | 430 |
| Example 1 | | | | | | | |
| Comparative | 1 | 2.32 | 292 | 85 | 104 | 10.5 | 480 |
| Example 2 | | | | | | | |
| Comparative | 5 | 2.34 | 299 | 88 | 109 | 4.6 | 430 |
| Example 3 | | | | | | | |

It will be understood that any one or more feature or component of one embodiment described herein can be combined with one or more other features or components of another embodiment. Thus, the present subject matter includes any and all combinations of components or features of the embodiments described herein.

As described herein above, the present subject matter solves many problems. However, it will be appreciated that various changes in the details, materials and arrangements of components and operations, which have been herein described and illustrated in order to explain the nature of the subject matter, may be made by those skilled in the art without departing from the principle and scope of the subject matter, as expressed in the appended claims.

1. A semi-aromatic polyamide resin formed from polymeric monomers, wherein the polymeric monomers comprise a diamine monomer and a diacid monomer,
wherein the diamine monomer comprises a diamine monomer A1 and a diamine monomer A2, and the diacid monomer comprises a diacid monomer B1 and a diacid monomer B2;
a carbon atom number C_{A1} of the diamine monomer A1 and a carbon atom number C_{A2} of the diamine monomer A2 satisfy that C_{A1}−C_{A2}≥4;
the diamine monomer A1 is at least one selected from the group consisting of 1,8-octanediamine, 1,9-nonanediamine, 1,10-decanediamine, 1,11-undecanediamine, 1,12-dodecanediamine, 1,13-tridecanediamine, and 1,14-tetradecanediamine;
the diamine monomer A2 is at least one selected from the group consisting of 1,4-butanediamine, 1,5-pentanediamine, 1,6-hexanediamine, 1,7-heptanediamine, 1,8-octanediamine, 1,9-nonanediamine, and 1,10-decanediamine;
the diacid monomer B1 is at least one selected from aromatic dicarboxylic acids with a carbon atom number of 7-12 and derivatives thereof; and
the diacid monomer B2 is at least one selected from aliphatic dicarboxylic acids with a carbon atom number of 4-18.

2. The semi-aromatic polyamide resin according to claim 1, wherein the diamine monomer A2 is at least one selected from diamines with a carbon atom number of 4-7;
the carbon atom number C_{A1} and the carbon atom number CM satisfy that 4≤C_{A1}−C_{A2}≤10;
the diacid monomer B1 is at least one selected from the group consisting of terephthalic acid, dimethyl terephthalate, isophthalic acid, and dimethyl isophthalate; or,
the diacid monomer B2 is at least one selected from the group consisting of 1,4-succinic acid, 1,5-glutaric acid, 1,6-adipic acid, 1,7-heptanedioic acid, 1,8-octanedioic acid, 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, and 1,18-octadecanedioic acid.

3. The semi-aromatic polyamide resin according to claim 1, wherein the polyamide resin comprises diamine units and diacid units prepared by polymerization between the diamine monomer and the diacid monomer, and a total weight of the diamine units and the diacid units is 97% or more of the polyamide resin.

4. The semi-aromatic polyamide resin according to claim 3, wherein the total weight of the diamine units and the diacid units is 99% or more of the polyamide resin.

5. The semi-aromatic polyamide resin according to claim 1, wherein the polyamide resin further comprises a polyamine, and the polyamine is at least one selected from the group consisting of thioether polyamine compounds, polyethyleneimine, and polyaminopolyether amines.

6. The semi-aromatic polyamide resin according to claim 5, wherein the polyamide resin comprises 0.8% or less by weight of the polyamine.

7. The semi-aromatic polyamide resin according to claim 1, wherein a molar ratio of total moles of the diamine monomer A2 and the diacid monomer B2 to total moles of all the polymeric monomers is between 0.040:1 and 0.099:1.

8. The semi-aromatic polyamide resin according to claim 1, wherein a molar ratio of the diamine monomer to the diacid monomer is between 1.01:1 and 1.03:1.

9. The semi-aromatic polyamide resin according to claim 1, wherein the polyamide resin further comprises an additive, and the additive is at least one selected from the group consisting of an end capping agent, a catalyst, a flame retardant, an antioxidant, an ultraviolet absorber, an infrared absorber, a crystallization nucleating agent, a fluorescent brightening agent, an antistatic agent, and combinations thereof.

10. The semi-aromatic polyamide resin according to claim 9, wherein the additive constitutes 0.01% to 3% by weight of the polyamide resin.

11. The semi-aromatic polyamide resin according to claim 1, wherein:
the polyamide resin has a relative viscosity of 1.8-2.6;
the polyamide resin has a melting point of 265-315° C.;
the polyamide resin has a tensile strength of 65-105 MPa;
the polyamide resin has a bending strength of 80-140 MPa; or
the polyamide resin has a flow length equal to or greater than 600 mm.

12. The semi-aromatic polyamide resin according to claim 11, wherein:
the polyamide resin has the relative viscosity of 2.0-2.5;
the polyamide resin has the melting point of 271-310° C.;
the polyamide resin has the tensile strength of 75-95 MPa;
the polyamide resin has the bending strength of 90-125 MPa; or
the polyamide resin has the flow length equal to or greater than 850 mm.

13. A method for preparing a semi-aromatic polyamide resin using polymeric monomers, wherein the polymeric monomers comprise a diamine monomer and a diacid monomer,
wherein the diamine monomer comprises a diamine monomer A1 and a diamine monomer A2, and the diacid monomer comprises a diacid monomer B1 and a diacid monomer B2;
a carbon atom number C_{A1} of the diamine monomer A1 and a carbon atom number C_{A2} of the diamine monomer A2 satisfy that C_{A1}−C_{A2}≥4;
the diamine monomer A1 is at least one selected from the group consisting of 1,8-octanediamine, 1,9-nonanediamine, 1,10-decanediamine, 1,11-undecanediamine, 1,12-dodecanediamine, 1,13-tridecanediamine, and 1,14-tetradecanediamine;
the diamine monomer A2 is at least one selected from the group consisting of 1,4-butanediamine, 1,5-pentanediamine, 1,6-hexanediamine, 1,7-heptanediamine, 1,8-octanediamine, 1,9-nonanediamine, and 1,10-decanediamine;
the diacid monomer B1 is at least one selected from aromatic dicarboxylic acids with a carbon atom number of 7-12 and derivatives thereof; and
the diacid monomer B2 is at least one selected from aliphatic dicarboxylic acids with a carbon atom number of 4-18,
wherein the method comprises:
heating an aqueous solution of a polyamide salt to 120-140° C., concentrating the aqueous solution, and then heating the aqueous solution to 230-260° C. for reaction; and
reducing pressure to 0-0.1 MPa (gauge pressure) by degassing,
wherein the aqueous solution of the polyamide salt is formed from the polymeric monomers and water.

14. The method according to claim 13, wherein:
concentrating the aqueous solution comprises draining water out to achieve a polyamide salt weight concentration of 40-80 wt. %;
the reaction is carried out for 0.5-2 h; or
the pressure is maintained at 2.0-3.5 MPa during the reaction.

15. The method according to claim 13, further comprising:
reducing the pressure to 0-0.02 MPa (gauge pressure) by degassing; and
the reaction system has a temperature of 295-335° C. after reducing pressure to 0-0.1 MPa (gauge pressure) by degassing.

16. The method according to claim 13, wherein before heating an aqueous solution of a polyamide salt, the method further comprises:
mixing polymeric monomers and water, heating to 70-95° C. to form the aqueous solution of the polyamide salt; or
mixing polymeric monomers and water, heating to 70-95° C., and holding the temperature at 70-95° C. for 0.5-3 hours to form the aqueous solution of the polyamide salt.

17. The method according to claim 13, wherein after reducing pressure to 0-0.1 MPa (gauge pressure) by degassing, the method further comprises:
vacuumizing to a vacuum degree of −0.02 MPa or less; or
vacuumizing to a vacuum degree of −0.02 MPa or less, and maintaining the vacuum degree for 0-300 s.

18. The method according to claim 13, further comprising:
adding an additive at any step of the method, and the additive is at least one selected from the group consisting of an end capping agent, a catalyst, a flame retardant, an antioxidant, an ultraviolet absorber, an infrared absorber, a crystallization nucleating agent, a fluorescent brightening agent, an antistatic agent, and combinations thereof.

19. A composition, comprising a semi-aromatic polyamide resin prepared by using polymeric monomers, wherein the polymeric monomers comprise a diamine monomer and a diacid monomer,
wherein the diamine monomer comprises a diamine monomer A1 and a diamine monomer A2, and the diacid monomer comprises a diacid monomer B1 and a diacid monomer B2;
a carbon atom number C_{A1} of the diamine monomer A1 and a carbon atom number C_{A2} of the diamine monomer A2 satisfy that C_{A1}−C_{A2}≥4;
the diamine monomer A1 is at least one selected from the group consisting of 1,8-octanediamine, 1,9-nonanediamine, 1,10-decanediamine, 1,11-undecanediamine, 1,12-dodecanediamine, 1,13-tridecanediamine, and 1,14-tetradecanediamine;
the diamine monomer A2 is at least one selected from the group consisting of 1,4-butanediamine, 1,5-pentanediamine, 1,6-hexanediamine, 1,7-heptanediamine, 1,8-octanediamine, 1,9-nonanediamine, and 1,10-decanediamine;
the diacid monomer B1 is at least one selected from aromatic dicarboxylic acids with a carbon atom number of 7-12 and derivatives thereof; and
the diacid monomer B2 is at least one selected from aliphatic dicarboxylic acids with a carbon atom number of 4-18, or
the semi-aromatic polyamide resin is prepared by:
heating an aqueous solution of a polyamide salt to 120-140° C., concentrating the aqueous solution, and then heating the aqueous solution to 230-260° C. for reaction; and
reducing pressure to 0-0.1 MPa (gauge pressure) by degassing,
wherein the aqueous solution of the polyamide salt is formed from the polymeric monomers and water.

20. An article, comprising the semi-aromatic polyamide resin of claim 1, the article is selected from the group consisting of electronic devices, automotive engine peripheral components, aerospace, and other articles for use in high temperature resistant fields.
